(19) United States
(12) Patent Application Publication
(10) Pub. No.: US 2012/0007825 A1
(43) Pub. Date: Jan. 12, 2012

(54) OPERATING MODULE OF HYBRID TOUCH PANEL AND METHOD OF OPERATING THE SAME

(75) Inventors: Woon Chun Kim, Gyunggi-do (KR); Yong Soo Oh, Gyunggi-do (KR); Jae Il Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/941,643

(22) Filed: Nov. 8, 2010

(30) Foreign Application Priority Data
Jul. 9, 2010 (KR) 1020100066366

(51) Int. Cl. G06F 3/044; G06F 3/045

(52) U.S. Cl. 345/174

(57) ABSTRACT

Disclosed herein is an operating module of a hybrid touch panel, including: an input unit 100 for touch input; a controller 200 that controls a driving type of a touch screen according to the touch input; a driver 300 that includes a resistive type driver and a capacitive type driver driving the touch screen according to the controller; and a display unit 400 that displays output values according to the touch input values. According to the present invention, it designs the operating module including the controller 200 that selectively drives the driving type of the touch panel according to the touch input, thereby making it possible to improve the reliability of the process outputting the desired results according to the touch input of the touch panel user and the accuracy of the touch input.

### CROSS REFERENCE TO RELATED APPLICATION

This application claims the benefit of Korean Patent Application No. 10-2010-0066366, filed on Jul. 9, 2010, entitled “Operating Module of Hybrid Touch Panel and Method of Operating the Same”, which is hereby incorporated by reference in its entirety into this application.

### 1. TECHNICAL FIELD

The present invention relates to an operating module of a hybrid touch panel and a method of operating the same.

### 2. DESCRIPTION OF THE RELATED ART

Alongside the growth of computers using digital technology, devices assisting computers have also been developed, for example, personal computers, portable transmitters and other personal information processors execute processing of text and graphics using a variety of input devices such as a keyboard, a mouse and so on. While the rapid advancement of the information-based society has been widening the use of computers more and more, there have been occurring the problems of it being difficult to efficiently operate products using only the keyboard and mouse, which is currently responsible for the input device function. Thus, the demand for a device that is simple, does not malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

A kind of the touch screen can be classified into a resistive type, a capacitive type, an electromagnetic type, a surface acoustic wave (SAW) type, and an infrared type.

Various types of touch screens are one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch screen. In particular, resistive and capacitive types are prevalently used.

Although the resistive type touch panel can perform a touch input through pen or all other devices, the capacitive type touch panel may be touched by a finger or a conductive device that is gripped by a hand. However, users using various applications through the touch panel adopt the driving types of the touch panel appropriate for each application to perform the touch input, such that the accuracy and reliability of the touch are improved, thereby making it possible to optimally use the functions of applications. In the prior art, all the applications are used by a single type such as the capacitive type or the resistive type, such that there is a problem in that the optimal touch type for each function and effect cannot be efficiently used. In addition, each driving type is not selectively driven according to the touch input values even in the case of the hybrid touch panel, such that there is a problem in that the touch panel cannot be optimally driven. Since the touch types meeting each application do not almost exist due to the above problems, inconvenience and accuracy of the touch input are degraded, such that there is a problem in that the use efficiency of the touch panel is reduced.

### SUMMARY OF THE INVENTION

The present invention has been made in an effort to provide an operating module of a hybrid touch panel and an operating method capable of providing reliable and accurate touch input of a touch panel by controlling driving of a capacitive type or a resistive type so that an operation of a hybrid touch panel meets each application.

An operating module of a hybrid touch panel according to a preferred embodiment of the present invention includes: an input unit for touch input; a controller that controls a driving type of a touch screen according to the touch input; a driver that includes a resistive type driver and a capacitive type driver driving the touch screen according to the controller; and a display unit that displays output values according to the touch input values.

A method of operating a hybrid touch panel according to a first preferred embodiment of the present invention includes: inputting a touch; determining a touch input unit; driving the touch screen according to the touch input unit; and displaying output values according to the driving the touch screen.

The determining the touch input unit determines whether the touch input unit is a person's hand or a pen, and the driving the touch screen drives the touch screen as a capacitive type if it is determined that the touch input unit is determined as a person's hand and drives the touch screen as a resistive type if it is determined that the touch input unit is determined as a pen.

A method of operating a hybrid touch panel according to a second preferred embodiment of the present invention includes: performing a touch input; determining coordinate regions that are input by the touch; driving the touch screen according to the coordinate regions that are input by the touch; and displaying output values according to the driving the touch screen.

The determining the coordinate regions that are input by the touch determines whether the coordinate values are positioned in any region of the capacitive type driving region and the resistive type driving region by calculating the coordinate values of the touched position, and the driving the touch screen drives the touch screen as the capacitive type if it is determined that the coordinate values by the touch input is determined in the capacitive type driving region and is driven as the resistive type if it is determined that the coordinate values by the touch input is in the resistive type driving region, at the determining the coordinate region of the touch input.

A method of operating a hybrid touch panel according to a third preferred embodiment of the present invention includes: performing touch input; determining whether a touch input value is in plural; driving a touch screen according to the touch input values; calculating a maximum value of pressure values at each touched coordinate if it is determined that the touch input value is in plural; and displaying output values of the touch input values according to the calculated maximum input value.

At the determining whether the touch input value is in plural, the touch screen is driven as the resistive type at the driving the touch screen if it is determined that the touch input value is in plural, and the touch screen is driven as the capacitive type or the resistive type at the driving the touch screen if it is determined that the touch input value is a single value.

At the determining whether the touch input value is in plural, the output values are displayed according to the touch input values at the touch coordinates corresponding to the case where the touch pressure value at each coordinate touched according to the plurality of touch inputs is determined as the maximum value if it is determined that the touch input value is in plural, and the operation of the touch panel ends when the touch pressure value at each coordinate touched according to the plurality of touch inputs is determined as a value other than the maximum value.

A method of operating a hybrid touch panel according to a fourth preferred embodiment of the present invention includes: performing touch input; first determining whether the touch input is a touch input of a specific icon group; second determining whether the touch input is a character input icon of the touched specific icon group; driving a touch screen according the touch input values according to the determining; and displaying output values through the driving the touch screen according to the touch input value.

The first determining whether the touch input is a touch input of a specific icon group passes through the second determining whether the icon is the character input icon when any one of the specific icon groups is touched, and the driving displays output values through the displaying by driving the touch screen as the capacitive type or the resistive type when the icons other than the specific icon group are touched.

At the second determining, when any one of the specific icon group is touched, the touched icon is a character input icon, the driving drives the touch screen in the resistive type, and when the touched icon is an icon other than the character input icon, the driving drives the touch screen as the capacitive type.

### BRIEF DESCRIPTION OF THE DRAWINGS

FIG. 1 is a diagram schematically showing an operating module of a hybrid touch panel according to the present invention;

FIG. 2 is a flow chart showing an operating method of a hybrid touch panel according to a first embodiment of the present invention;

FIG. 3 is a flow chart showing an operating method of a hybrid touch panel according to a second embodiment of the present invention;

FIG. 4 is a flow chart showing an operating method of a hybrid touch panel according to a third embodiment of the present invention; and

FIG. 5 is a flow chart showing an operating method of a hybrid touch panel according to a fourth embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

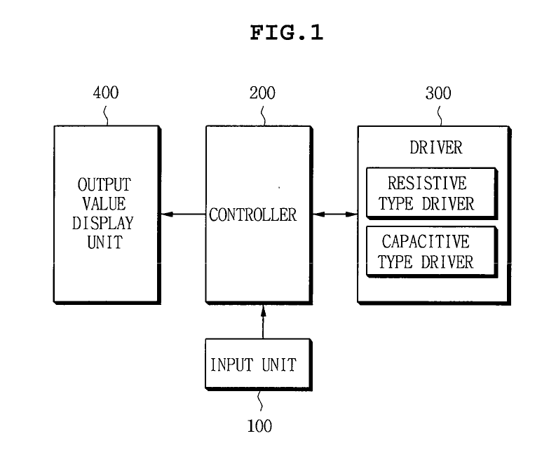

FIG. 1 is a diagram schematically showing an operating module of a hybrid touch panel according to the present invention. An operating module of a hybrid touch panel according to the present invention includes an input unit 100 for a touch input, a controller 200 that controls a driving type of a touch screen according to the touch input, a driver 300 including a resistive type driver and a capacitive type driver that drives the touch screen according to the controller; and a display unit 400 that displays output values according to touch input values.

The input unit 100 serves to input specific values by a touch. The input method of the input unit 100 may be variously made. However, it is preferable that the present invention performs the input by the touch unit since the present invention relates to the operating module of the touch panel.

The controller 200 serves to select the driving type of the hybrid touch panel according to the touch values input through the input unit 100. The controller 200 optionally drives the driving type of either the capacitive type or the resistive type in order to operate the touch panel according to the touch input values in an optimal environment. The driving type of the hybrid touch panel can be controlled by various types such as the driving control according to the touch unit, the driving control according to the touch input values, the driving control according to coordinate values of the touched position, the driving control according to a kind of touched icons, and the like, as in the operating method of the touch panel to be described below, In addition to this, the driving type of the hybrid touch panel can be controlled by the control of the touch input values of various types.

The driver 300 is configured to include the capacitive type driver and the resistive type drive and drives the touch panel according to the driving type adopted in the controller 200.

The output value display unit 400 displays the output values obtained through the driving of the driver 300. For example, the output value display unit 400 may output and display the values through the display, and the like.

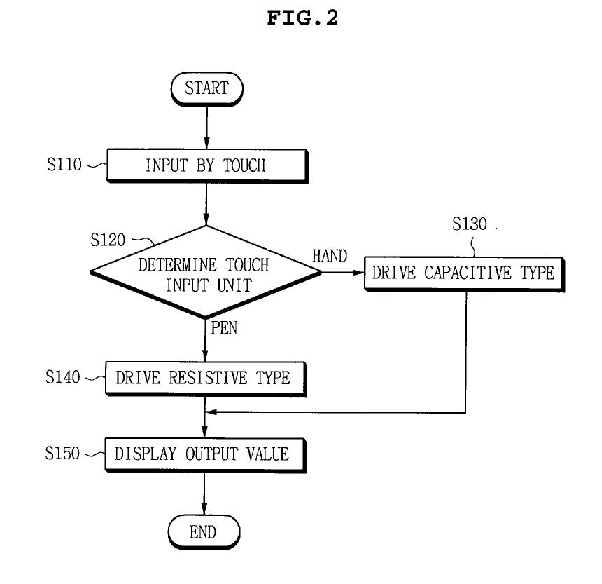

FIG. 2 is a flow chart showing an operating method of a touch panel according to a first embodiment of the present invention. An operating method of a touch panel according to a first embodiment of the present invention includes inputting a touch, determining a touch input unit, driving a touch screen according to the touch input unit, and displaying output values according to the driving the touch screen.

A first step is a touch input step (S110). The first step is a step of inputting touch to the touch panel through the touch unit. The touch input may be different according to the capacitive type or the resistive type, but the touch unit is not specifically limited. However, the capacitive type is generally touch input by hand while the resistive type is generally input by input devices such as a separate pen, etc. In addition, in the case of the resistive type, the touch input may be made by a finger, etc. However, in the case of the resistive type, a predetermined pressure should be input and in the case of the capacitive type, the touch input can be made by only contacting the touch panel that is touched by the conductive device, etc.

A second step is a step of determining the touch input unit (S120). The second step adopts the appropriate driving type of the touch panel according to the touch input unit. Generally, a representative touch input unit of the touch input unit is a pen or a finger. In order to perform input such as writing, painting, etc., it is preferable to use the resistive type touch panel and in order to change a display by the contact of a finger, etc., it is preferable to use the capacitive type. In particular, the capacitive type has a disadvantage in that accuracy or reliability of touch is degraded when performing the fine touch input, etc., as compared to the resistive type. Therefore, the driving type of the touch panel is controlled according to the kind of touch input unit in consideration of the advantages and disadvantages of each touch input unit, thereby driving the hybrid touch panel using the capacitive type or the resistive type.

A third step is a step of driving the capacitive type touch panel that can perform the touch input by only the light touch rather than the fine touch in the case where the touch input unit is a finger (S130). On the other hand, a fourth step is a step of driving the touch panel by the resistive type when fine touch should be made by the touch input unit such as a pen, etc. Each step adopts the driving type of the touch panel that can optimized the effects according to the touch input unit, thereby improving accuracy and reliability of the touch input by the user that uses the touch panel and convenience of the touch input of the user.

A fifth step is a step of displaying the output values according to each input value when the touch input values are input according to each driving type (S150). The user of the touch panel can confirm his/her desired information or various data through the display step (S150).

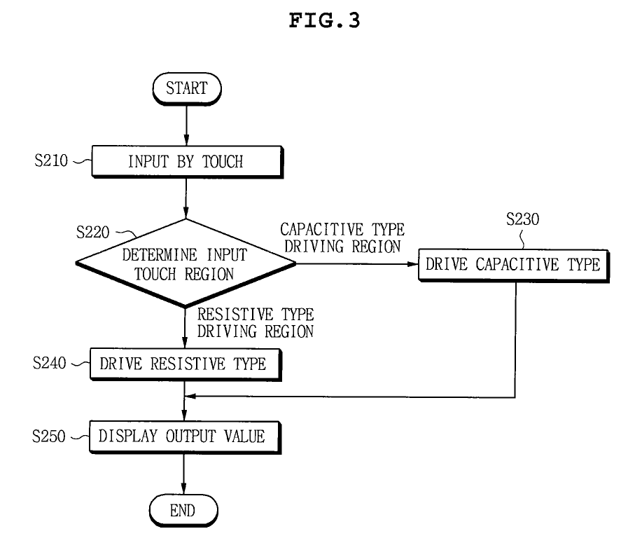

FIG. 3 is a flow chart showing an operating method of a touch panel according to a second embodiment of the present invention. An operating method of a touch panel according to a second embodiment of the present invention includes inputting a touch, determining coordinate regions that are input by the touch, driving the touch screen according to the coordinate regions that are input by the touch, and displaying the output values according to the driving the touch screen.

A first step is an input step by the touch (S210). The input by the touch may be made by a finger as well as various input units.

A second step is a step of determining where the values input by the touch are formed in any region of the touch panel (S220). That is, the second step is a step of determining the coordinate regions that are input by the touch (S220). Herein, the separate touch driving type is driven by touching each of the region driving the capacitive type and a region driving the resistive type that are divided according to the characteristics of various icons formed on the touch panel.

A third step is a step of driving the capacitive type when the coordinate regions that are input by the touch is formed in the region where the capacitive type is driven (S230). Various icons that can be easily input by a light touch and icons that can operate applications with a rapid and light touch rather than by the fine and accurate touch are formed in the region in which the capacitive type is driven. Therefore, the region in which the icons are optimized for the driving type as the capacitive type are formed is set, thereby driving the touch panel as the capacitive type meeting the characteristics of each icon.

A fourth step is a step of driving the resistive type when the coordinate regions that are input by the touch is formed in the region where the resistive type is driven (S240). Icons having applications requiring the fine touch input such as inputting characters by writing implements, etc., are formed in the region in which the resistive type is driven. In addition, icons appropriately driven by the resistive type such as controlling the touch input by pressure are formed. Therefore, the region in which the icons optimized for the driving type as the resistive type are formed is set, thereby driving the touch panel by the resistive type meeting the characteristics of each icon.

A fifth step is a step of displaying the output values according to the touch input values by driving the touch panel through the third step and the fourth step (S250). The capacitive type or the resistive type is adopted and optionally driven according to the functions and characteristics of each icon, thereby making it possible to obtain more accurately and reliably output values through the input of the touch panel.

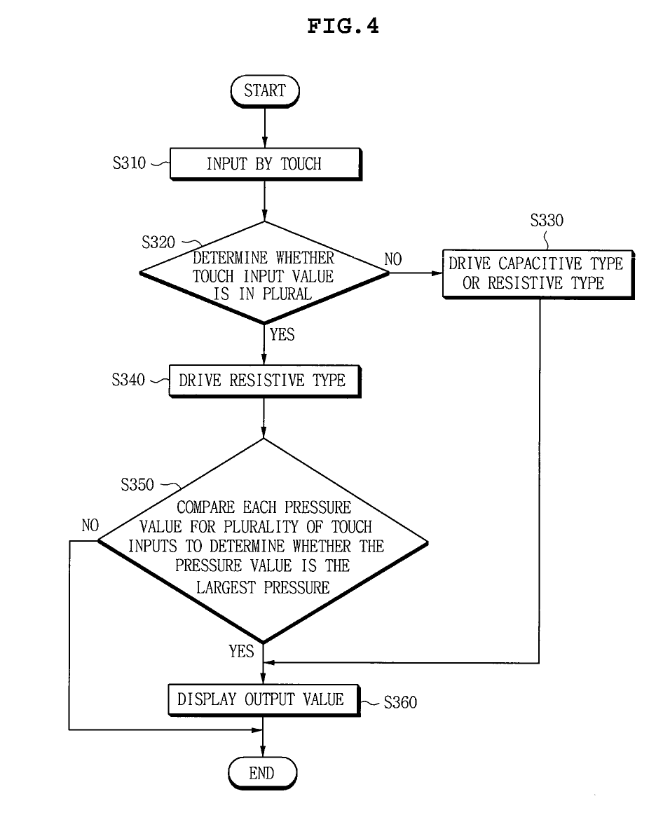

FIG. 4 is a flow chart showing an operating method of a touch panel according to a third embodiment of the present invention. A method of operating a touch panel according to a third embodiment of the present invention includes inputting a touch; determining whether a touch input value is in plural; driving a touch screen according to the touch input values; determining whether the touch input value is a maximum value of pressure values at each touched coordinate if it is determined that the touch input value is in plural; and displaying output values of the touch input values according to the determining whether the touch input value is the maximum value.

A first step is an input step by the touch (S310). The input by a touch may be made by a finger as well as various input units.

A second step is a step of determining whether the touch input value is in plural (S320). The second step means that the plurality of touch input values are input as two or more icons are touched when the desired icon is touched. In particular, since the touched area is wide at the time of the finger touch, it means the case where other icons adjacently formed other than the icons to be touched by the user are simultaneously formed. When all of two or more icons are touched in the range of the touched area, any one of the touch input values should be adopted, which is a value that the user wants to have. Herein, as two or more icons are simultaneously touched, if the plurality of touch input values are input, they are determined as to which driving type of the touch panel is first adopted.

The third step corresponds to the case where the touch input value is not input in plural. In this case, since one icon is normally touched, the third step is a step of driving the touch panel as the capacitive type or the resistive type. (S330).

A fourth step is the case where the touch input value is input in plural. In this case, any one of the plurality of touch input values should be adopted. Although the user desired icon is touched, icons adjacent thereto can be simultaneously touched and the touched area or the touch pressure are differently indicated. Therefore, the fourth step is a step of driving the resistive type touch panel if the plurality of touch input values are input (S340). The fourth step selects the correct one of the plurality of touch input values through the step of comparing each touch pressure value applied at the time of touch to be described below.

The fifth step is driven as the resistive type and is a step of determining whether the pressure value is the maximum pressure value by comparing each pressure value applied at the time of a plurality of touches. The fifth step calculates the largest pressure value among each touch pressure value applied at the time of touch and displays the user desired output value by adopting the touch input value at the corresponding coordinate. When the touch pressure value is not the maximum pressure value, the operation of the touch panel ends without displaying the separate output value.

A sixth step is a step of displaying output values according to touch input values through each driving step of the touch panel (S360). However, during the process of comparing the pressure values applied at the time of the touch as in the fifth step, the operation of the touch panel directly ends without displaying a separate output value for the touch input value at a coordinate corresponding to a value other than the maximum pressure value.

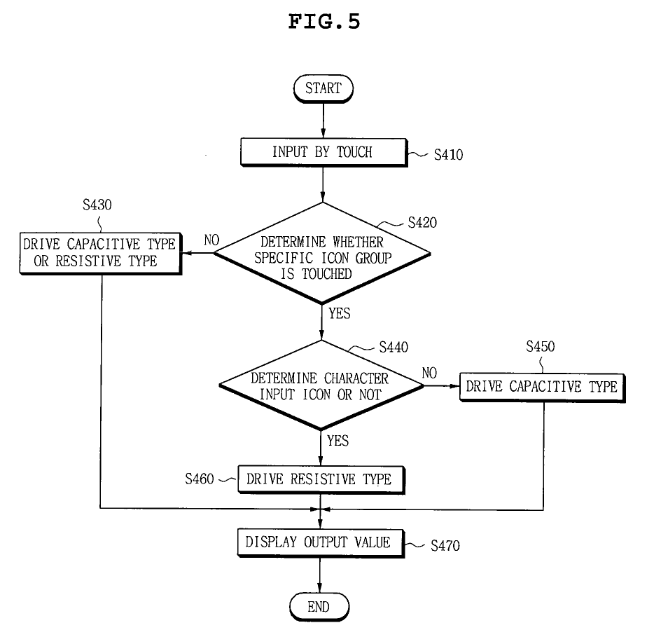

FIG. 5 is a flow chart showing an operating method of a touch panel according to a fourth embodiment of the present invention. An operating method of a touch panel according to a fourth embodiment of the present invention includes inputting a touch; first determining whether the touch input is a touch input of a specific icon group; second determining whether the touch input is a character input icon of the touched specific icon group; driving a touch screen according the touch input values according to the determining step; and displaying output values through the driving the touch screen according to the touch input value.

A first step is an input step by the touch (S410). The input by the touch may be made by a finger as well as various input units.

A second step is a first determining that determines whether the specific icon group is a touch input (S420). The specific icon group of the second step means a group configured of each icons meeting the touch panel driving type of either the capacitive type and the resistive type. For example, in the case of the resistive type, the touch by using a pen can be made, it is advantageous in using the character input related icons. In addition, the icons suitable for the soft touch or the light touch such as the change of the display increase the input of the user and convenience of use when driving the touch panel in the capacitive type. Therefore, the icons meeting each driving type are set as one group to control the driving type for each icon. Prior to performing the control, whether the touch input value of the user belongs to the specific icon group is determined.

The third step is a step of driving the touch panel in the capacitive type or the resistive type when the icon other than the specific icon group is touched (S430) and proceeds to a step of displaying the output values according to each touch input value (S470).

The fourth step is a second determining step that determines whether the touched icon belongs to the character input related icon when the touch input of the user is an icon in the specific icon group (S440). In the case of directly inputting the characters on the touch screen or the character input key input icon on the touch screen such as the character input related icon, for example, a memo pad, an icon transmitting characters, etc., since a fine touch input is required, the touch unit such as the touch pen is required. Therefore, in the case of the capacitive type, when the function of the character input related icon is used, an input error or the accuracy of the touch is degraded. As a result, it is more preferred to drive the touch panel as the resistive type. The fourth step is a step of determining whether the touched icon is the character input related icon (S440) and the driving type of the touch panel is selectively driven at the following step.

The fifth step is a step of adopting the driving type suitable for the functions and effects of the icon according to the driving of the touch panel as the capacitive type when the touch input icon is not the character input related icon (S450). It proceeds to displaying the corresponding output value by driving the touch panel as the capacitive type (S470).

The sixth step is a step of driving the touch panel as the resistive type to perform the fine touch input such as the character input when the touch input icon is the character in put related icon as described above (S460). The touch panel is driven as the resistive type to secure accuracy and easiness of the input of the touch screen, thereby making it possible to obtain the output values by the user desired touch.

A seventh step is a step of displaying output values according to each touch input value driven according to the capacitive type or the resistive type (S470).

According to the present invention, it designs the operating module including the controller that selectively drives the driving type of the touch panel according to the touch input, thereby making it possible to improve the reliability of the process outputting the desired results and the accuracy of the touch input.

Further, the present invention controls the driving type as the capacitive type or the resistive type according to the input unit of the touch panel to adopt the driving type corresponding to the input unit, thereby making it possible to improve the reliability, speed, and accuracy of the touch input.

In addition, the present invention divides and controls the driving region according to the capacitive type or the resistive type when each icon of the touch panel is disposed, thereby making it possible to improve the reliability, speed, and accuracy of the touch input and adopt the driving type meeting the functions and effects of each icon.

Further, the present invention performs a control to drive the resistive type when there are the plurality of touch input values in order to reduce noise at the time of the input of the touch panel that adopt the touch input values having the highest pressure value by measuring the applied touch pressure when the touch panel is touched, such that the user desired touch input values are displayed as the adopted output values.

Further, the present invention sets the group of icons that are effective in the case of adopting the resistive type and the groups of icons that are effective in the case of adopting the capacitive type, such that the user can perform the touch input by the driving type of the touch panel meeting the functions and effects of each icon.

Although the embodiment of the present invention has been disclosed for illustrative purposes, it will be appreciated that an operating module of a hybrid touch panel and a method of operating the same according to the invention are not limited thereby, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. An operating module of a hybrid touch panel, comprising:
an input unit for touch input;
a controller that controls a driving type of a touch screen according to the touch input;
a driver that includes a resistive type driver and a capacitive type driver driving the touch screen according to the controller; and
a display unit that displays output values according to the touch input values.

2. A method of operating a hybrid touch panel, comprising:
inputting a touch;
determining coordinate regions that are input by a touch input unit or touch;
driving the touch screen according to the coordinate regions that are input by the touch input unit or the touch; and
displaying output values according to the driving the touch screen.

3. The method of operating a hybrid touch panel as set forth in claim 2, wherein the determining the touch input unit determines whether the touch input unit is a person's hand or a pen, and
the driving the touch screen drives the touch screen as a capacitive type if it is determined that the touch input unit is determined as a person's hand and drives the touch screen as a resistive type if it is determined that the touch input unit is determined as a pen.

4. The method of operating a hybrid touch panel as set forth in claim 2, wherein the determining the coordinate regions that are input by the touch determines whether the coordinate values are positioned in any region of the capacitive type driving region and the resistive type driving region by calculating the coordinate values of the touched position, and the driving the touch screen drives the touch screen as the capacitive type if it is determined that the coordinate values by the touch input is determined in the capacitive type driving region and is driven as the resistive type if it is determined that the coordinate values by the touch input is in the resistive type driving region, at the determining the coordinate region of the touch input.

5. A method of operating a hybrid touch panel, comprising:
inputting a touch;
determining whether a touch input value is in plural;
driving a touch screen according to the touch input values;
determining whether the touch input value is a maximum value of pressure values at each touched coordinate if it is determined that the touch input value is in plural; and
displaying output values of the touch input values according to the determining whether the touch input value is the maximum value.

6. The method of operating a hybrid touch panel as set forth in claim 5, wherein at the determining whether the touch input value is in plural,
the touch screen is driven as the resistive type at the driving of the touch screen if it is determined that the touch input value is in plural, and
the touch screen is driven as the capacitive type or the resistive type at the driving the touch screen if it is determined that the touch input value is a single value.

7. The method of operating a hybrid touch panel as set forth in claim 6, wherein at the determining whether the touch input value is in plural,
the output values are displayed according to the touch input values at the touch coordinates corresponding to the case where the touch pressure value at each coordinate touched according to the plurality of touch inputs is determined as the maximum value if it is determined that the touch input value is in plural, and
the operation of the touch panel ends when the touch pressure value at each coordinate touched according to the plurality of touch inputs is determined as a value other than the maximum value.

8. A method of operating a hybrid touch panel, comprising:
inputting a touch;
first determining whether the touch input is a touch input of a specific icon group;
second determining whether the touch input is a character input icon of the touched specific icon group;
driving a touch screen according the touch input values according to the determining; and
displaying output values through the driving the touch screen according to the touch input value.

9. The method of operating a hybrid touch panel as set forth in claim 8, wherein the first determining whether the touch input is a touch input of a specific icon group passes through the second determining whether the icon is the character input icon when any one of the specific icon groups is touched, and the driving displays output values through the displaying by driving the touch screen as the capacitive type or the resistive type when the icons other than the specific icon group are touched.

10. The method of operating a hybrid touch panel as set forth in claim 9, wherein at the second determining,
any one of the specific icon group is touched,
when the touched icon is a character input icon, the driving drives the touch screen as the resistive type, and
when the touched icon is an icon other than the character input icon, the driving drives the touch screen as the capacitive type.
